(19) United States
(12) Patent Application Publication
(10) Pub. No.: US 2014/0052653 A1
(43) Pub. Date: Feb. 20, 2014

(54) System And Method For Completing, Validating And Submitting Regulatory Forms

(71) Applicant: Frederick Douglas SCHWENK, New York, NY (US)

(72) Inventor: Frederick Douglas SCHWENK, New York, NY (US)

(21) Appl. No.: 13/968,005

(22) Filed: Aug. 15, 2013

Related U.S. Application Data
(60) Provisional application No. 61/684,469, filed on Aug. 17, 2012.

(51) Int. Cl. G06Q 30/00

(52) U.S. Cl. CPC G06Q 30/018
USPC 705/317

(57) ABSTRACT

A non-transitory computer-readable storage medium stores a set of instructions executable by a processor, the set of instructions, when executed by the processor, causing the processor to perform operations including receiving an instruction to complete a regulatory form for a private entity, collecting data relating to the regulatory form from a data source, formatting the data for insertion into the regulatory form, populating a plurality of fields of the regulatory form with the formatted data, and submitting the populated regulatory form to a governmental regulatory entity.

### PRIORITY CLAIM/INCORPORATION BY REFERENCE

This application claims priority to U.S. application Ser. No. 61/684,469 entitled “System And Method For Completing, Validating And Submitting Regulatory Forms,” filed on Aug. 17, 2012. The entirety of the above-identified application is incorporated by reference into this application.

### BACKGROUND INFORMATION

Many government agencies require the submission of forms by private entities due to statutory enactment. This is especially true in the financial industry. For example, statutes such as Dodd-Frank and Sarbanes-Oxley require multiple submissions of a substantial quantity of diverse information. These statutes not only require the submission of information, but also impose corporate liability on the entity and personal liability on certain persons within the entity for both the submission of information and the accuracy of the information. Thus, it is extremely important to timely file accurate submissions.

In one example, the Securities and Exchange Commission (“SEC”) and the Commodity Futures Trading Commission (“CFTC”) have proposed the submission of Form PF for private fund advisers. All registered advisers must file Section 1 yearly, while large Private Fund Advisers ($1.5B+) must file quarterly. The Form PF requires performance, strategy, exposures, and more. The advisor itself only retains a portion of that data. As such, the completion of the form will require any advisor to access data from external systems and to calculate answers from the combined pool of data.

### SUMMARY OF THE INVENTION

The present invention is directed to a non-transitory computer-readable storage medium including a set of instructions executable by a processor, the set of instructions, when executed by the processor, causing the processor to perform operations including receiving an instruction to complete a regulatory form for a private entity, collecting data relating to the regulatory form from a data source, formatting the data for insertion into the regulatory form, populating a plurality of fields of the regulatory form with the formatted data, and submitting the populated regulatory form to a governmental regulatory entity.

The present invention is further directed to a system including a processor, a user interface, a network interface and a memory. The memory stores a set of instructions that, when executed by the processor, cause the processor to perform operations comprising receiving, via the user interface an instruction to complete a regulatory form for a private entity, collecting data relating to the regulatory form from a data source, formatting the data for insertion into the regulatory form, populating a plurality of fields of the regulatory form with the formatted data, and submitting the populated regulatory form to a governmental regulatory entity via the network interface.

### BRIEF DESCRIPTION OF THE DRAWINGS

FIG. 1 shows a schematic flow for the submission of a form to a government agency according to an exemplary embodiment.

FIG. 2 shows a schematic diagram of a submission system according to an exemplary embodiment.

FIG. 3 shows an exemplary method for the submission of a form to a government agency using the exemplary system of FIG. 2.

FIG. 4 shows a first exemplary screen shot provided to a user of the exemplary system of FIG. 2.

FIG. 5 shows a second exemplary screen shot provided to a user of the exemplary system of FIG. 2.

FIG. 6 shows a third exemplary screen shot provided to a user of the exemplary system of FIG. 2.

FIG. 7 shows a fourth exemplary screen shot provided to a user of the exemplary system of FIG. 2.

FIG. 8 shows a fifth exemplary screen shot provided to a user of the exemplary system of FIG. 2.

### DETAILED DESCRIPTION

The exemplary embodiments of the present invention allow for the completion and submission of government forms (e.g., Form PF). The forms may be integrated into the exemplary embodiment; for example, in a software-based exemplary embodiment, the software may be provided to a user with the forms included. Additionally, a software-based exemplary embodiment may be configured to communicate with the relevant government agency to ensure that forms are up-to-date. The exemplary embodiments are operable to extract information from a variety of sources and place this information into the correct format for governmental form submission.

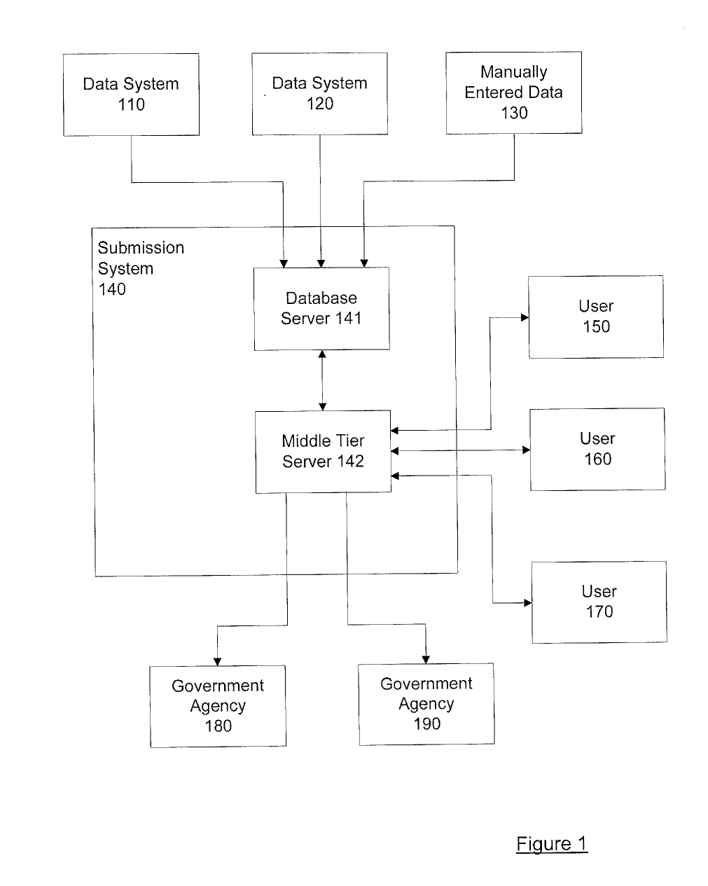

FIG. 1 shows a schematic flow 100 for the submission of a form to a government agency. In this example, a private entity is required to submit one or more forms to multiple government agencies 180 and 190 (e.g., the SEC and the CFTC). The private entity operates a submission system 140 that submits the required forms to the government agencies 180 and 190. The private entity also operates a series of separate data systems 110-130 that include the information for completion of the form. For example, the data systems 110-130 may include a trading system, a risk management system, a CRM system, etc. In one exemplary embodiment, data stored in the data systems 110-130 may be stored in a comma-separated value (“CSV”) format. In another exemplary embodiment, data stored in the data systems 110-130 may be stored in an Extensible Markup Language (“XML”) format. However, these specific formats are only exemplary, and the submission system may be configured to access information stored in any other appropriate format.

As shown in FIG. 1, one type of the data systems 110-130 may comprise manually entered data 130. Thus, throughout this description it should be understood that any references to the data systems 110-130 may include automated systems operated by the private entity or data entered manually by the private entity. Those of skill in the art will understand that, depending on the type of private entity, many different types of systems may be operated by the entity. Each of the data systems 110-130 may have information that is needed to complete a portion of the required forms. Those skilled in the art will understand that the data systems 110-130, individually or collectively, may have the information required to complete the form or may have the information used to derive the information that is necessary for the form. For example, one form may require a private entity to quantify the percentage of equity trades that were OTC trades in the last quarter; in an embodiment in which the data system 110 is a trading system that includes records for all the trades in the last quarter including whether the trade was an OTC trade, the percentage of OTC trades could be derived from this stored information.

Data stored in the data systems 110-130 and to be imported by the submission system 140 may include static data (i.e., data that remains constant regardless of the time at which the form is being completed) as well as dynamic data (i.e., data that varies over time and whose specific values vary depending on when the form is being completed). For the exemplary embodiment where the form being filled out is Form PF, static data may include a customer name, an affiliate name, a fund class, a fund relationship, a counterparty master, and a counterparty affiliation. For the same exemplary embodiment, dynamic data may include assumptions, a security master, fund holdings, fund trades, fund GL, financing available, investor master, investor affiliation, investor account, fund performance, risk VAR, other risk metrics, change in market factor, and standard final answers to be used in completing the form.

The submission system 140 may store one or more form types that can be completed by the submission system. A more detailed description of the various features of the submission system 140 will be provided below. However, in general, the submission system 140 has the ability to request information from each of the data systems 110-130 based on the form that is being completed. For example, it can be considered that there is a very simple form that has three (3) sections. The data system 110 may include the information to complete the first section, the data system 120 may include the information to complete the second section, and the data system 130 may include the information to complete the third section. The submission system 140 can retrieve the required information for the first, second and third sections from the data systems 110, 120 and 130, respectively. The submission system 140 may have default settings as to which of the data systems 110-130 should be used to retrieve specific information, or the submission system may be configurable by a user, such that each private entity may configure the submission system 140 to retrieve information from the one of the data systems 110-130 which the private entity desires. The submission system 140 may then complete the form and submit the completed form to the correct government agency 180 or 190. The submission system 140 may also be configured to retrieve information from the data system 110-130 in a specialized format that allows the submission system 140 to calculate answers and subsequently populate the form with the calculated answers.

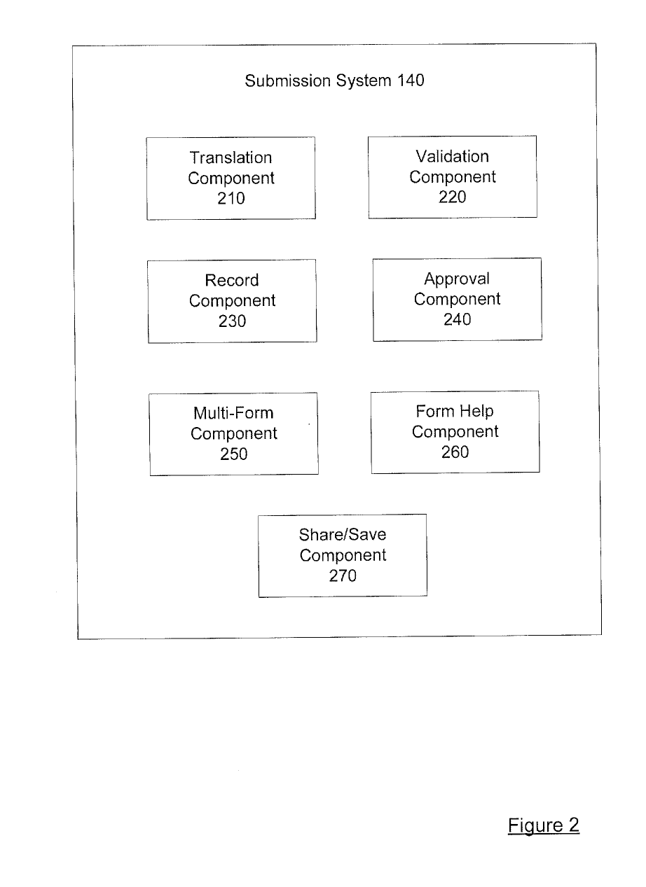

The exemplary submission system 140 may include a database server 141 to interface with the data systems 110-130. The database server 141 may be used to store the information that is retrieved from the data systems 110-130. As described above, this information will be used to complete the required form. The submission system 140 further includes a middle tier server 142 that includes the functionality for completing the form. This functionality may include, for example, retrieving and processing information from the database server 141, populating this processed information into the correct location and format on the form, interfacing with users 150-170 who are individuals at the private entity responsible for completing the form, and communicating with the systems of the government agencies 180-190 to submit the form. Additional functionality that is resident in either or both of the database server 141 and middle tier server 142 is further described with reference to the exemplary components of the submission system 140 as shown in FIG. 2.

As shown in FIG. 1, the users 150-170 have access to the forms via interfacing with the middle tier server 142. The users 150-170 may be granted various permissions based on their position or job title with the private entity to view, manipulate and/or approve various information populated in the form.

The exemplary submission system 140 may also be used without the database or middle tier servers, in which case users 150-170 may interface with the submission system 140 directly to populate the form by either importing or manually entering data into the system.

In the above-described exemplary embodiment, a submission system 140 controlled by a private entity retrieved information from data systems 110-130 also controlled by the private entity in order to fill out the form that is to be submitted by the private entity. However, the submission system 140 is not limited to retrieving information from data systems 110-130 that are controlled or operated by the private entity. It may be that the information that the private entity needs to complete the form is controlled by another entity. Thus, the submission system 140 may be configured to allow the importation of compatible data from data systems controlled by another entity (e.g., prime broker, fund administrator, custodian, or other service provider).

FIG. 2 shows a schematic diagram of the submission system 140 including various components and features. Each of these features will be described in more detail below. However, it should be noted that the exemplary submission system 140 is not limited to the described components and features, but may also include additional functionality.

A first component is a translation component 210 that implements a process by which the submission system 140 translates data from the data systems 110-130 into a usable form. As described above, the submission system 140 may retrieve information from any data system (e.g., data system 110-130). However, neither the type of information nor the manner in which the information is stored is uniform across multiple data systems. Thus, the submission system 140 must translate the information into a usable form so that the information may be properly completed into the form that is being filled out. For example, the translation component 210 may retrieve information from spreadsheets, manually entered answers, database files, storage arrays, etc. and convert that data into a usable XML file. The translation component 210 also allows the automatic linking of data by linking to, for example, Excel spreadsheets. Each input item in the form can be linked to a different cell or cells in one or more Excel spreadsheets such that as a user is filling out a form, the data from a particular spreadsheet cell or series of cells is used for the portion of the form being currently filled out. The translation component 210 also allows for the submission system 140 to answer particular questions on a form by applying translated information imported from data systems 110-130 to a customized set of calculations based on the particular form being currently filled out.

A second component is validation component 220 which implements an error checking process by which the submission system 140 (a) ensures that answers fit the requirements of the form in terms of acceptable responses and (b) checks for internal consistency where dependent values are involved. The validation component 210 may perform one or more of the following checks. For example, the validation component 220 may determine whether values are reasonable, given the data requested; whether required inputs are filled, plus any dependencies; whether values tie across the form; whether totals match detail; whether values are within acceptable tolerance of prior temporal values (e.g., was there a substantial increase or decrease in a value from a past submission); and whether the values will pass the agency validations (e.g., each agency requires the forms to be submitted with a specific format such as number of decimal places, specific date format, etc.).

A further component is a record component 230 that allows the submission system 140 the ability to create a record trail including, for example, (a) user created notes, (b) attached files, and (c) linking of spreadsheets that allows the submission system to perform a records management function to assist in future audits and to provide internal support for answers. The record component 230 may also, for example, capture in one place various information to support the input that will be filed. In one exemplary embodiment, right-clicking on each form input allows a user to access the backup information. This is a handy detail to support a subsequent SEC exam in which the private entity is required to provide the data and methodology supporting each submitted answer. This includes such information as user activity (e.g., a historic record of each change to the input, the user making the change, and the time of the change), notes (e.g., any notes the user may wish to record), source data or source information (e.g., trades, positions, investor accounts that was used to calculate an answer), calculation methodology (e.g., information about the specific calculation used), and any backup files.

Another component is an approval component 240 that allows submission system 140 to implement an approval process for each of the forms. In one exemplary embodiment, an approval process requires certain users, or groups of users, to sign off on an answer before it can be submitted and then locks that answer for editing once it is approved. The approval hierarchy is entirely flexible to user structure. For example, an administrative user may define an approval workflow which includes a series of users and or user groups that are required to “approve” an item and all users that must approve, or at least one user must approve an item. The users that are part of the approval workflow may then approve items. The approval component 240 may also implement a reporting feature that shows the items that have already been approved and the items that still need to be approved before filing. This report may be, for example, by user, by form section, etc. The approval component 240 also prevents the form from being filed with the regulator if the form is not fully approved.

Another component is a multi-form component 250 that allows the submission system 140 to compare forms across multiple filings according to user selected tolerances. The multi-form component 250 allows the submission system to track, visualize, and reconcile similar data across various regulatory filings and other reporting and record information to support the difference in two values that have the same meaning.

Another component of the submission system 140 is a form help component 260 that provides information for each form that the submission system 140 is configured to complete. The form help component 260 may include instructions for each line item in a form such that the instructions are displayed next to the respective input in the form. The instructions may be based on, for example, the instructions of the governmental agency that requires the form. The form help component 260 may further include links to definitions or other helpful information for filling out the selected form.

A further component of the submission system 140 is a share/save component 270 that allows the files to be shared with other users of the form or saved for future reference. For example, when creating the next filing (e.g., the next quarter), a user can start with the previous filing to minimize data entry. The share/save component 270 also allows the form to be printed via a hard copy of the form with the entered data or create a PDF of the forms with entered data using several popular programs. The share/save component 270 also allows the saving of defaults for each input item to minimize repetitive input. These defaults can be shared with other users by copying the settings file.

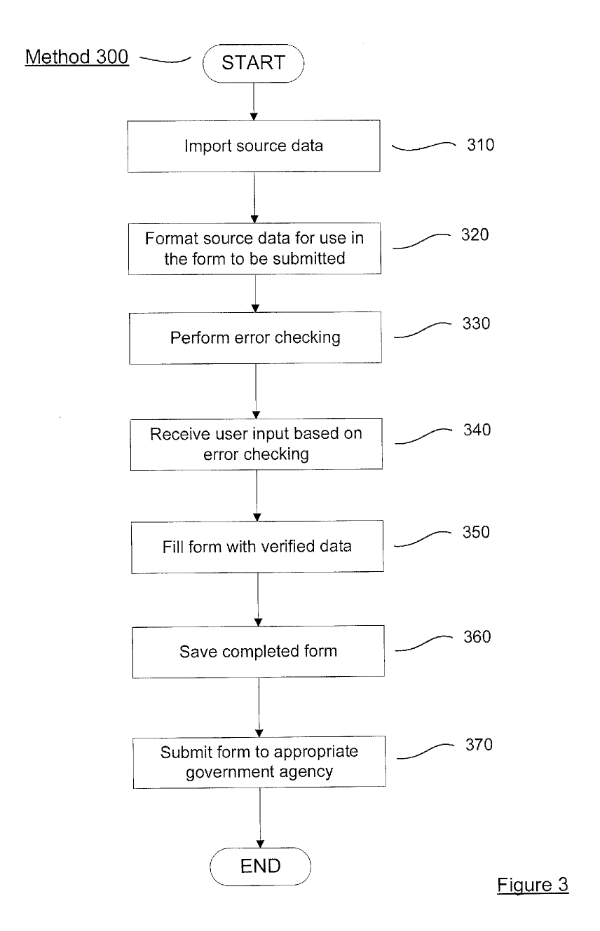

FIG. 3 illustrates an exemplary method 300 by which a form may be completed and submitted through the use of a system such as the submission system 140 of FIGS. 1 and 2. In one exemplary embodiment, the method 300 may be initiated by a user of the submission system 140 providing an instruction to complete the form; in another embodiment, the submission system 140 may be configured to perform the method 300 without a user instruction at an appropriate time, such as prior to a deadline for submission of the form. Additionally, the performance of method 300 may be monitored by record component 230 of submission system 140, in order that records of the submission of the form by the submission system 140 are created in the event that the performance needs to be subsequently reviewed.

In step 310, the submission system 140 imports data from the appropriate source or sources (e.g., one or more of data systems 110-130) for the selected form. This may involve a user of the submission system 140 selecting one or more source data files, or, alternately, the submission system 140 may be configured to select the appropriate source data files. For the exemplary embodiment in which the form is Form PF, the data that is imported may include fund information, financing information, performance information, risk analytics information, position information, exposure information, and investor information. It will be apparent to those of skill the art that the specific data to be imported may vary in an embodiment in which a different form is being completed by submission system 140. In step 330, the data imported in step 310 is translated and formatted appropriately for use in the form by translation component 210 of submission system 140 as described above.

In step 330, the validation component 220 of submission system 140 performs an error checking process on the data that has been formatted in step 320 to ensure that the final data is appropriate for use in the form. As described above, this may involve determining whether values are reasonable, whether all inputs are filled, whether values are within an acceptable tolerance of prior values, whether the values are formatted properly for the agency that will receive the form, etc. Potential errors may be highlighted for review by a user of the submission system 140, along with providing an explanation of why the potential error has been highlighted. The error checking process may also be performed by the multi-form component 250, which may compare forms across multiple filings in the manner described above.

In step 340, the submission system 140 receives input from a user to approve or disapprove of the data that has been checked in step 330. This may be accomplished by means of the approval component 240, as described above, which may provide the user with a prompt asking the user to sign off on an answer prior to submission and then lock the answer for further editing. Where the user disapproves of the existing answer, the user may edit the answer before approving it. As described above with reference to the approval component 240, the approval process may include an approval workflow whereby multiple users may be required to approve one or more items, where the approval of various items is subdivided among appropriate users, or in other manners consistent with division of responsibility within the entity that is using the submission system 140. During this process, the user or users may access form help component 260, which may provide the user or users with instructions or other helpful information for filling out the form.

In step 350, the data that has been approved in step 340 is filled in to the form that is being completed by submission system 140. Those of skill in the art will understand that this may involve a mapping by which the submission system 140 is preconfigured to place each of a plurality of given imported data values into a corresponding field in the form. After the data has been filled in to the form in step 350, in step 360 the completed form may be saved using the share/save component 270 of submission system 140. The storage may occur locally to the submission system or in a remote storage. In another exemplary embodiment, the share/save component 270 may share the finalized form with one or more of the users 150-170 or other individuals to whom the form may be relevant. Finally, in step 370, the completed form may be submitted to the government agencies 180-190. In one exemplary embodiment, this may involve electronic submission via the Internet; in another embodiment, the form may be printed and submitted in a hard copy version. Following step 370, the method 300 is complete.

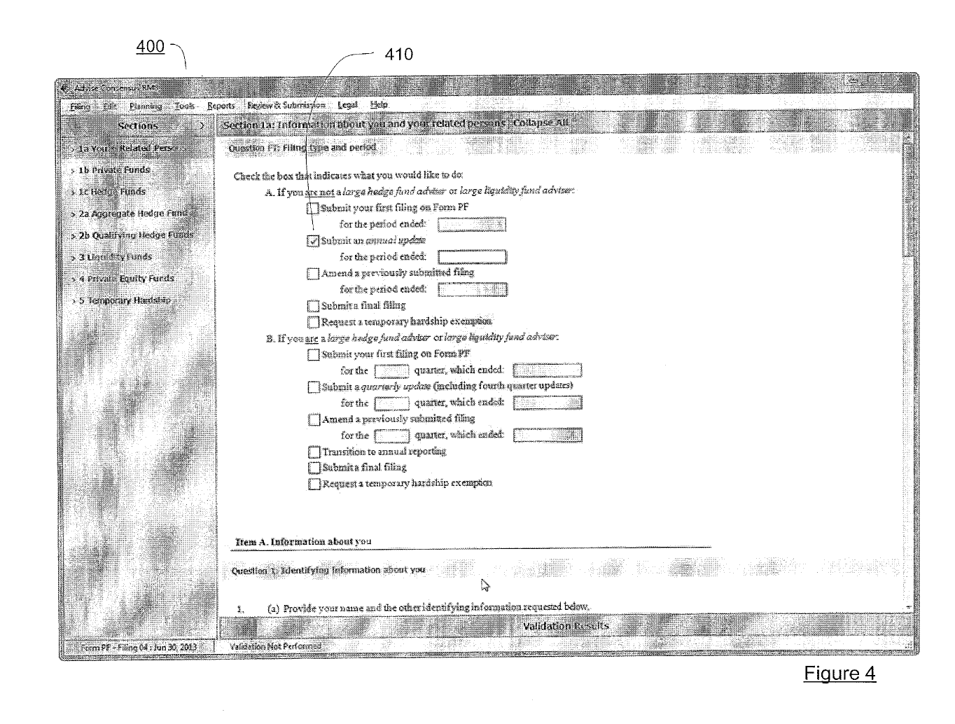

FIG. 4 illustrates a first exemplary screen shot 400 of a computer-implemented exemplary embodiment of the submission system 140. In the screen shot 400, a user of the submission system 140 is provided with various options for selecting the form to be completed by the submission system 140. The user may be prompted with various options including submitting an initial annual or quarterly filing, submitting an annual or quarterly update, amending a previous annual or quarterly filing, submitting a final filing, requesting a hardship extension, or transitioning from quarterly to annual filings. The choice between submitting annual filings and submitting quarterly filings may be made based on the size of the entity for which the user is submitting the filing; for example, a large hedge fund adviser or large liquidity fund adviser may be required to submit quarterly filings, while other entities may be required to submit annual filings. The user may be provided with a set of check boxes corresponding to the above options and may check a box 410 corresponding to the selected filing.

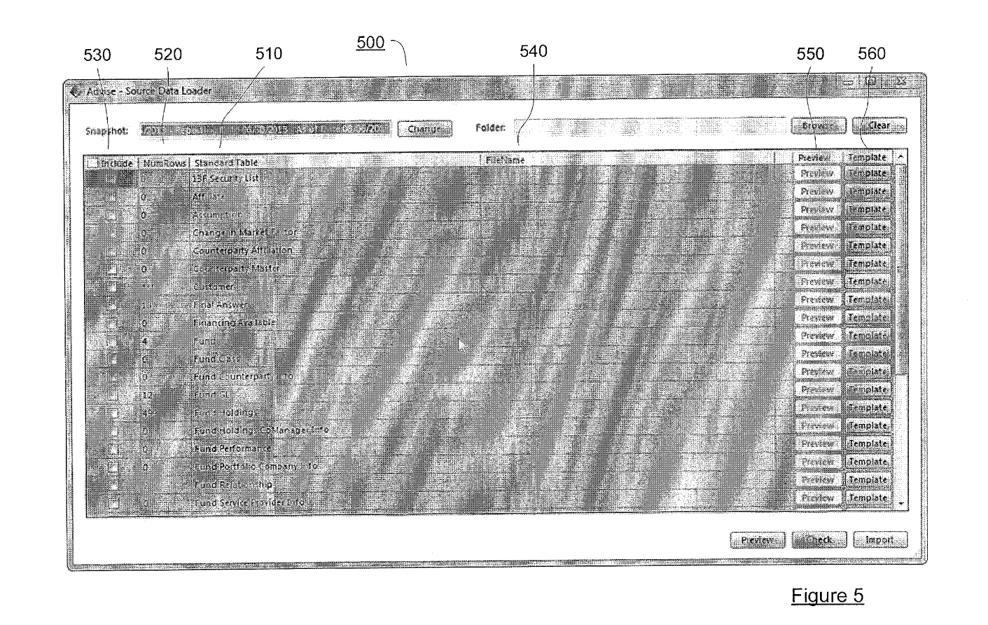

FIG. 5 illustrates a second exemplary screen shot 500 of a computer-implemented exemplary embodiment of the submission system 140. In the screen shot 500, a user of the submission system 140 is provided with various options for source data that may be selected for inclusion into the form to be completed by submission system 140. The options may be provided in a table format, with a column 510 showing each of the options, a column 520 showing the number of rows of data available for each of the options, a column 530 providing the user with check boxes to select each of the options, a column 540 providing the user with a file name for each of the options, a column 550 allowing the user to preview each of the options, and a column 560 allowing the user to view a template for each of the options.

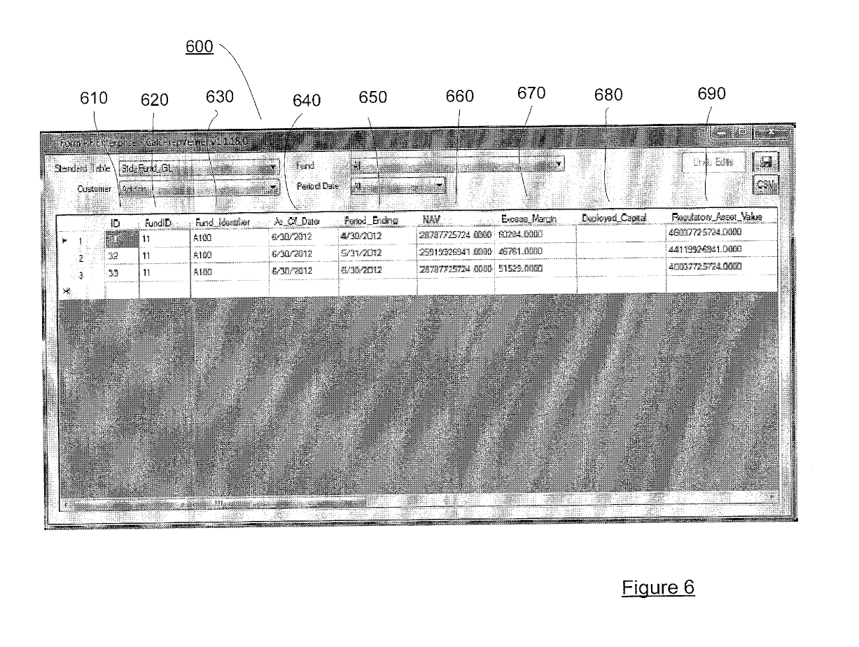

FIG. 6 illustrates a third exemplary screen shot 600 of a computer-implemented exemplary embodiment of the submission system 140. In the screen shot 600, a user of the submission system 140 is provided with a display showing a portion of the source data loaded by the submission system 140. The information about the source data may be provided in a table format, with a column 610 showing a data identifier, a column 620 showing a fund identifier, a column 630 showing a second fund identifier, a column 640 showing an as-of date, a column 650 showing a period end date, a column 660 showing the range of a particular set of data such as a net asset value (“NAV”), a column 670 showing an excess margin, a column 680 showing a deployed capital value, and a column 690 showing a regulatory asset value.

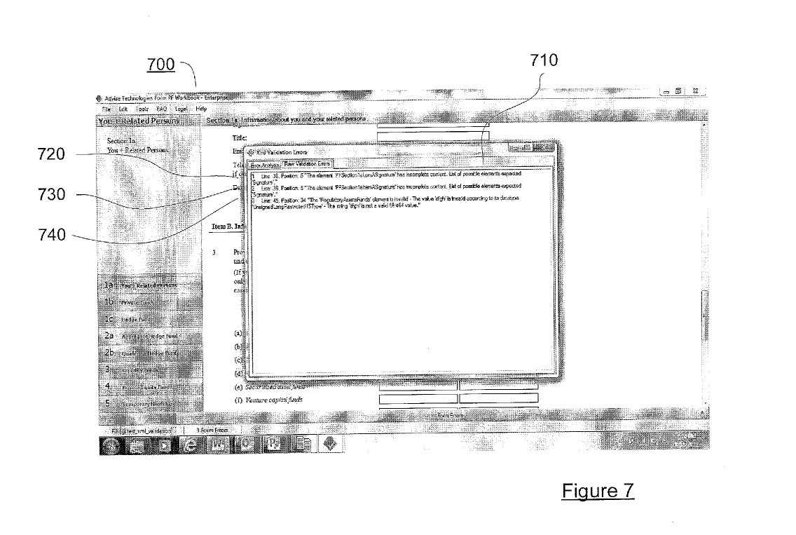

FIG. 7 illustrates a fourth exemplary screen shot 700 of a computer-implemented exemplary embodiment of the submission system 140. In the screen shot 700, a user of the submission system 140 is provided with a display that enables error checking by the user. The screen shot 700 may include a textual display 710 indicating errors 720, 730 and 740 to the user, so that the user may remedy the errors.

The exemplary submission system 140 also allows for the creation of unique reports relating to submission status and activity. Submissions may be very complex and can involve dozens of users or require the approval of specific groups based on the internal governance of the entity. Users of the submission system 140 may choose to receive reports detailing the status of all approved/unapproved items and a full audit history detailing the time and nature of each change to a submission and the user responsible.

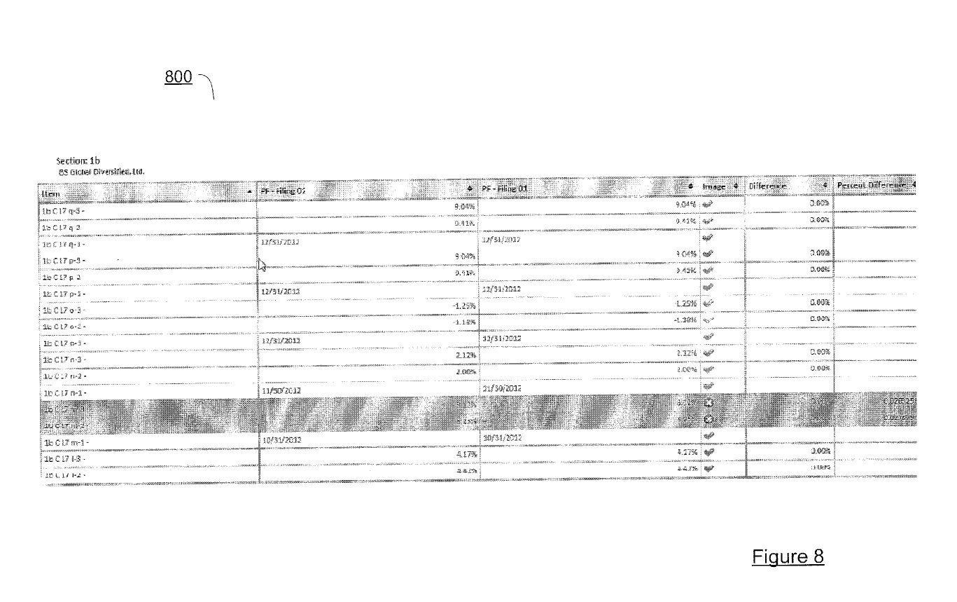

FIG. 8 illustrates a fifth exemplary screen shot 800 of a computer-implemented exemplary embodiment of the submission system 140. In the screen shot 800, a user of the submission system 140 is provided with a display of a report comparing multiple submissions produced by the submission system 140 over a period of time. The comparison report may alert the user to changes in submission data points that are greater than the report's established sensitivity criteria.

The exemplary embodiments have been described with specific reference to a private entity submitting forms related to financial reporting (e.g., Form PF) to a governmental entity such as the SEC or the CFTC. However, it will be apparent to those of skill in the art that this is only exemplary, and that the broader principles described by the exemplary embodiments are equally applicable to the creation of any regulatory filing or private report that involves the inputting, calculation, and verification of a variety of data.

Those skilled in the art will understand that the above-described exemplary embodiments of the submission system may be implemented in any suitable software or hardware configuration or combination thereof. An exemplary hardware platform for implementing the exemplary embodiments may include, for example, an Intel x86 based platform with compatible operating system, a Mac platform and MAC OS, etc. The exemplary system may further include a user interface for receiving user input and providing the user with information, and a network interface for retrieving data and submitting completed forms. In a further example, the exemplary embodiments of the submission system 140 may be a program containing lines of code stored on a non-transitory computer readable storage medium that, when compiled, may be executed on a processor.

What is claimed is:

1. A non-transitory computer-readable storage medium storing a set of instructions executable by a processor, the set of instructions, when executed by the processor, causing the processor to perform operations comprising:
receiving an instruction to complete a regulatory form for a private entity;
collecting data relating to the regulatory form from a data source;
formatting the data for insertion into the regulatory form;
populating a plurality of fields of the regulatory form with the formatted data; and
submitting the populated regulatory form to a governmental regulatory entity.

2. The non-transitory computer-readable storage medium of claim 1, wherein the operations further comprise:
generating a comparison of the regulatory form to a prior regulatory form; and
displaying the comparison to a user.

3. The non-transitory computer-readable storage medium of claim 1, wherein the data source comprises manually entered data.

4. The non-transitory computer-readable storage medium of claim 1, wherein the data is collected from a plurality of data sources.

5. The non-transitory computer-readable storage medium of claim 1, wherein the regulatory form is Form PF.

6. The non-transitory computer-readable storage medium of claim 1, wherein the method further comprises:
generating a log of the performance of the steps of collecting data, formatting the data, and populating the plurality of fields.

7. The non-transitory computer-readable storage medium of claim 1, wherein the method further comprises:
providing, to a user, an indication of a possible error in one of the fields of the regulatory form.

8. The non-transitory computer-readable storage medium of claim 7, wherein the possible error relates to an unreasonable value, a missing input, a value that is not within a proper tolerance of a prior value, and an improper format.

9. The non-transitory computer-readable storage medium of claim 7, wherein the method further comprises:
receiving, from the user, one of a correction of the possible error and an approval of the possible error.

10. The non-transitory computer-readable storage medium of claim 1, wherein the data comprises one of a customer name, an affiliate name, a fund class, a fund relationship, a counterparty master, a counterparty affiliation, an assumption, a security master, a fund holding, a fund trade, a fund GL, a financing available, an investor master, an investor affiliation, an investor account, a fund performance, a risk VAR, a risk metric, a change in market factor, and a standard final answer.

11. A system, comprising:
a processor;
a user interface;
a network interface; and
a memory storing a set of instructions that, when executed by the processor, cause the processor to perform operations comprising:
receiving, via the user interface an instruction to complete a regulatory form for a private entity;
collecting data relating to the regulatory form from a data source;
formatting the data for insertion into the regulatory form;
populating a plurality of fields of the regulatory form with the formatted data; and
submitting the populated regulatory form to a governmental regulatory entity via the network interface.

12. The system of claim 11, wherein the operations further comprise:
generating a comparison of the regulatory form to a prior regulatory form; and
providing the comparison to a user via the user interface.

13. The system of claim 11, wherein the data source comprises data that is manually entered via the user interface.

14. The system of claim 11, wherein the data is collected from a plurality of data sources.

15. The system of claim 11, wherein the regulatory form is Form PF.

16. The system of claim 11, wherein the operations further comprise:
generating a log of the performance of the steps of collecting data, formatting the data, and populating the plurality of fields; and
storing the log in the memory.

17. The system of claim 11, wherein the operations further comprise:
providing, via the network interface, an indication of a possible error in one of the fields of the regulatory form.

18. The system of claim 17, wherein the possible error relates to an unreasonable value, a missing input, a value that is not within a proper tolerance of a prior value, and an improper format.

19. The system of claim 17, wherein the operations further comprise:
receiving, via the network interface, one of a correction of the possible error and an approval of the possible error.

20. The system of claim 11, wherein the data comprises one of a customer name, an affiliate name, a fund class, a fund relationship, a counterparty master, a counterparty affiliation, an assumption, a security master, a fund holding, a fund trade, a fund GL, a financing available, an investor master, an investor affiliation, an investor account, a fund performance, a risk VAR, a risk metric, a change in market factor, and a standard final answer.
